(19) United States
(12) Patent Application Publication
(10) Pub. No.: US 2004/0229763 A1
(43) Pub. Date: Nov. 18, 2004

(54) Cleaning kit and/or a dishwashing kit containing a foam-generating dispenser and a cleaning and/or dishwashing composition

(75) Inventors: Howard David Hutton III, Cincinnati, OH (US); Richard Emil Hildebrand IV, West Chester, OH (US); Christopher Lamb, Ohain (BE); Kevin George Goodall, Tervuren (BE); Ronald David Turner, Elsmere, KY (US); Peter Robert Foley, Cincinnati, OH (US)

Correspondence Address: THE PROCTER & GAMBLE COMPANY, INTELLECTUAL PROPERTY DIVISION, WINTON HILL TECHNICAL CENTER - BOX 161, 6110 CENTER HILL AVENUE, CINCINNATI, OH, 45224, US

(73) Assignee: The Procter & Gamble Company

(21) Appl. No.: 10/787,342

(22) Filed: Feb. 26, 2004

Related U.S. Application Data
(60) Provisional application No. 60/472,954, filed on May 23, 2003.
(60) Provisional application No. 60/451,063, filed on Feb. 28, 2003.

(51) Int. Cl. C11D 1/00

(52) U.S. Cl. 510/220; 510/221

(57) ABSTRACT

A dishwashing kit contains a container with a foam-generating dispenser and a dishwashing composition within the container. The dishwashing composition contains a surfactant system and solvent. When the foam-generating dispenser is employed with the dishwashing composition, the foam-generating dispenser may generate a foam having a foam to weight ratio of greater than about 2 mL/g. When dispensed from the foam-generating dispenser, the dishwashing composition may also have an effective foaming dilution range of at least about 50% of the dilution range. When dispensed from the foam-generating dispenser, the dishwashing composition may also have an effective foaming dilution range which overlaps an effective solubilization dilution range. When dispensed from the foam-generating dispenser, the dishwashing kit may also generate a foam at a substantially different dishwashing composition to water dilution than the dilution at which the maximum volume of foam is formed according to a suds cylinder test. An instruction set may also be present, including a recommendation to employ the dishwashing composition in combination with a foam-generating dispenser. A cleaning kit contains a container with a foam-generating dispenser and a microemulsion and/or protomicroemulsion cleaning composition within the container. The cleaning composition contains a surfactant system and solvent. When the foam-generating dispenser is employed with the cleaning composition, the foam-generating dispenser may generate a foam having a foam to weight ratio of greater than about 2 mL/g.

### CROSS REFERENCES TO RELATED APPLICATIONS

This application claims the benefit of the filing date of U.S. Patent Application No. 60/472,954, filed May 23, 2003, which claims the benefit of the filing date of U.S. Patent Application No. 60/451,063, filed Feb. 28, 2003, which are incorporated by reference herein.

### FIELD OF THE INVENTION

The present invention relates to cleaning compositions and containers therefor. Specifically, the present invention relates to cleaning compositions and foam-generating dispensers.

### BACKGROUND OF THE INVENTION

During cleaning, especially dishwashing, and more especially manual dishwashing, voluminous foam is viewed as a direct indicator of the proper dishwashing composition concentration and/or water dilution factor. In a consumer cleaning product consumers also view suds as an indication of how well the composition is cleaning and/or removing oil and soils. It is a natural habit for a person washing dishes to add more dishwashing composition when the foam level or volume decreases, as the cleaning performance is viewed as directly correlated to the foam level; as the foam level decreases, the cleaning performance is perceived as decreasing. While such a direct correlation was true in the past when, for example, when only soap-based detergents existed, this consumer perception is inaccurate when considering certain modern surfactant systems.

It has now been found that in the use of a microemulsion and certain other modern cleaning compositions, the sudsing profile may not directly correspond to the most effective cleaning concentration. For example, traditional nonionic surfactant-based microemulsions may possess their maximum grease absorbing capabilities at dilution levels where little or no foam will occur, even with the regular agitation such as occurs during manual dishwashing. In fact, in certain microemulsion systems, the microemulsion itself acts to prevent or reduce foam formation during normal dishwashing. Similarly, a highly concentrated anionic surfactant system containing alkyl ethoxy sulfate may not possess significant foaming characteristics, even though the system is able to effectively and efficiently remove significant amounts of grease and oils from dishes, flatware, and even plastic. Consumers, however, are reluctant to purchase and use such dishwashing compositions, as the compositions are viewed as lacking in suds and therefore (incorrectly) also viewed as lacking acceptable cleaning performance. To overcome such a lack of foam, chemical suds boosters have been added to many manual dishwashing formulations; however, such suds boosters can be expensive and provide little or no actual cleaning benefits. In addition to raising formulation costs, suds boosters may also be incompatible with certain surfactant systems.

Containers and specifically dispensing containers for forming a foam are well known in the trigger-sprayer and aerosol arts, the toilet bowl cleaning art, the shaving foam art, and the hand and body washing arts. Such dispensers typically contain a gas injection mechanism such as an air-injection piston, a propellant gas, a foam-generating aperture, and/or a pressurized gas which is turbulently combined with a liquid soap as it exits the container. By employing this turbulent mixing and/or foam-generating aperture, a foam is created, which is then used for washing the hands, and/or body. Such foaming hand and body washes as specifically preferred by some consumers as they are believed to be gentle and mild to the skin, while easily and evenly spreading across skin. In addition, while foam-generating dispensers are also known for cleaning purposes such as car washing, and industrial cleaning, such foam-generating dispensers have not hereto before been used for containing and dispensing a dishwashing composition.

Accordingly, the need exists for an improved cleaning and/or dishwashing composition which possesses acceptable sudsing without the need for suds boosters. The need also exists for a cleaning and/or dishwashing kit which generates foam where the oil solubilization is maximized, and which provides acceptable foaming at a dilution where the dishwashing composition's oil solubilization characteristics are higher than they are at the dilution where acceptable foam forms during use.

### SUMMARY OF THE INVENTION

The present invention relates to a dishwashing kit containing a container with a foam-generating dispenser and a dishwashing composition within the container. The dishwashing composition contains a surfactant system and solvent. When the foam-generating dispenser is employed with the dishwashing composition, the foam-generating dispenser generates a foam having a foam to weight ratio of greater than about 2 mL/g.

The present invention also relates to a dishwashing kit containing a container with a foam-generating dispenser and a dishwashing composition within the container. The dishwashing composition contains a surfactant system and solvent. When dispensed from the foam-generating dispenser, the dishwashing composition has an effective foaming dilution range of at least 50% of the dilution range.

The present invention also relates to a dishwashing kit containing a container with a foam-generating dispenser and a dishwashing composition within the container. The dishwashing composition contains a surfactant system and solvent. When dispensed from the foam-generating dispenser, the dishwashing composition has an effective dilution range which overlaps an effective oil solubilization range.

The present invention also relates to a dishwashing kit containing a container with a foam-generating dispenser and a dishwashing composition within the container. The dishwashing composition contains a surfactant system and a solvent. When dispensed from the foam-generating dispenser, the dishwashing kit generates foam at a substantially different dishwashing composition to water dilution than the dilution at which the maximum volume of foam is formed according to a suds cylinder test.

The present invention also relates to a dishwashing composition containing a surfactant system, a solvent, and an instruction set. The instruction set includes a recommendation to employ the dishwashing composition in combination with a foam-generating dispenser. When the foam-generating dispenser is employed with the dishwashing composition, the foam-generating dispenser generates at least about 2 mL foam per mL of the dishwashing composition and the foam has a foam to weight ratio of greater than about 2 mL/g.

Finally, the present invention also relates to a cleaning kit containing a container with a foam-generating dispenser and a microemulsion and/or protomicroemulsion composition within the container. The composition contains a surfactant system and solvent. When the foam-generating dispenser is employed with the composition, the foam-generating dispenser generates a foam having a foam to weight ratio of greater than about 2 mL/g.

It has now been found that the combination of a foam-generating dispenser and a dishwashing composition can simultaneously provide both acceptable foaming and higher oil solubilization characteristics. Without intending to be limited by theory, it is believed that when plotted as a function of dilution with water, the typical in-use suds generation curve and oil solubilization curve tend not to significantly overlap, especially in the case of a microemulsion dishwashing composition and/or a protomicroemulsion dishwashing composition. However, by employing a foam-generating dispenser to dispense a dishwashing composition, the user is positively encouraged to employ the dishwashing composition when the oil solubilization and cleaning is more effective. Accordingly, such a combination is believed to result is significantly cleaner dishes, reduced effort, reduced formulation costs, and more effective use of the dishwashing composition.

These and other features, aspects, advantages, and variations of the present invention, and the embodiments described herein, will become evident to those skilled in the art from a reading of the present disclosure with the appended claims, and are covered within the scope of these claims.

### BRIEF DESCRIPTION OF THE FIGURES

While the specification concludes with claims particularly pointing out and distinctly claiming the invention, it is believed that the invention will be better understood from the following description of the accompanying figures in which like reference numerals identify like elements, and wherein:

FIG. 1 is a cut-away view of a preferred embodiment of the foam-generating dispenser;

FIG. 2 is a top perspective, cut-away view of a preferred embodiment of the shaped applicator; and

FIG. 3 is a perspective, cut-away view of a preferred embodiment of the shaped applicator.

FIG. 4 is a graph of several suds generation curves.

The figures herein are not necessarily drawn to scale.

### DETAILED DESCRIPTION OF THE INVENTION

All percentages, ratios and proportions herein are by weight of the final dishwashing composition, unless otherwise specified. All temperatures are in degrees Celsius (° C.) unless otherwise specified.

As used herein, the term “comprising” means that other steps, ingredients, elements, etc. which do not affect the end result can be added. This term encompasses the terms “consisting of” and “consisting essentially of”.

As used herein, the term “dish” means any dishware, tableware, cookware, glassware, cutlery, cutting board, food preparation equipment, etc. which is washed prior to or after contacting food, being used in a food preparation process and/or in the serving of food.

As used herein, the terms “foam” and “suds” are used interchangeably and indicate discrete bubbles of gas bounded by and suspended in a liquid phase.

As used herein, the term “microemulsion” means a oil-in-water emulsion which has the ability to emulsify oil into non-visible droplets. Such non-visible droplets typically have maximum diameter of less than about 100 angstroms (Å), preferably less than 50 Å as measured by methods known in the art, such as ISO 7027 which measures turbidity at a wavelength of 880 nm. Turbidity measuring equipment is easily available from, for example, Omega Engineering, Inc., Stamford, Conn., U.S.A.

As used herein, the term “protomicroemulsion” means a composition which may be diluted with water to form a microemulsion.

Container

The container useful herein has a hollow body for holding a dishwashing composition, and is typically a bottle or canister formed of plastic, glass, and/or metal, preferably a polymer or resin such as polyethylene, polypropylene, polyethylene terephthalate, polycarbonate, polystyrene, ethyl vinyl alcohol, polyvinyl alcohol, thermoplastic elastomer, and combinations thereof, although other materials known in the art may also be used. Such containers will typically hold from about 100 mL to about 2 L of liquid, preferably from about 150 mL to about 1.2 L of liquid, and more preferably from about 200 mL to about 1 L of liquid, and are well known for holding liquid consumer products. Such containers are widely available from many packaging suppliers.

Operatively attached to the container either directly or indirectly is a foam-generating dispenser for generating a foam. When activated, the foam-generating dispenser generates foam and concurrently dispenses the foam/dishwashing composition from the container. The foam-generating dispenser may be formed as either integral with, or separate from the container. If formed separately, the foam-generating dispenser may attach to the container via methods known in the art such as by employing a transition piece, corresponding threaded male and female members, pressurized and non-pressurized seals, locking and snap-on parts, and/or other methods known in the art. Preferably, the foam-generating dispenser is attached to the container via a transition piece and/or with corresponding threaded male and female members which allow easy refilling.

The foam-generating dispenser may generate a foam via any method, such as a chemical reaction, an enzymatic reaction, and/or a mechanical action. However, a mechanical action is preferred herein, and typically involves a mechanism which imparts a gas, such as air, nitrogen, carbon dioxide, etc., directly into the dishwashing composition in a turbulent manner as it dispenses, so as to physically form the foam. Preferably, the foam-generating dispenser includes a gas imparting mechanism to form the foam, such as, for example, a propellant or liquefied gas, a pressurized gas, an aerosol gas, an air injection piston, foam-generating aperture, an impinging surface, a mesh or net, a pump, and/or a sprayer, more preferably, an air injection piston, a pump, an impinging surface, a mesh or net, and/or a sprayer which injects or imparts air from the atmosphere into the dishwashing composition.

The foam-generating dispenser also typically includes an activator, preferably a manual activator such as, for example, a trigger, a pressure-activated pumping mechanism, a button, and/or a slider, more preferably a trigger and/or a pressure-activated pumping mechanism which can be activated with a single finger. It is highly preferred that the activator be designed such that a consumer may easily activate it when their hands are wet and/or slippery, such as when in the middle of a manual dishwashing process. Such an activator should allow the user to easily and conveniently control both the speed of dispensing and the volume dispensed. For certain applications, such as in industry or in public facilities, other activators may be useful, such as an electronic activator, a computer-controlled activator, an electric eye or an infrared detection activator, a manual lever-assist activator, etc.

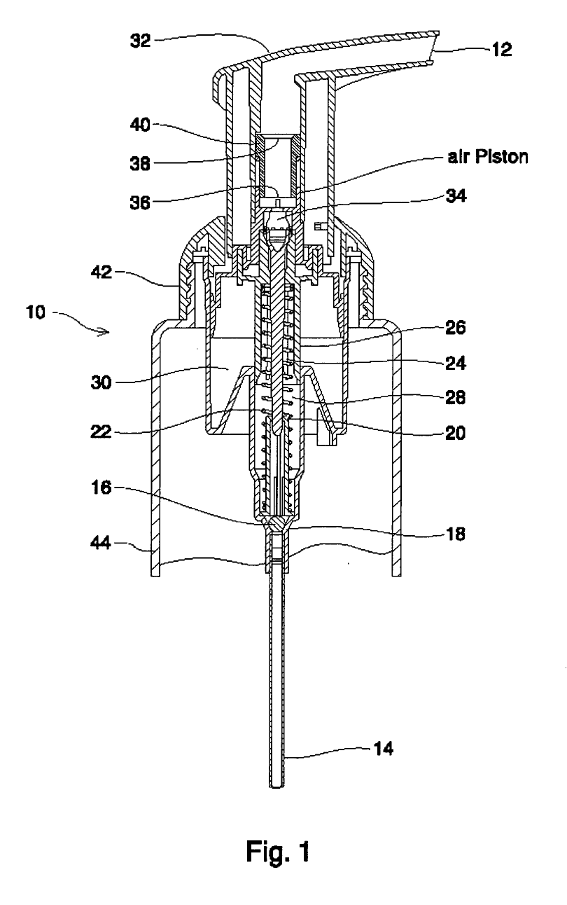

FIG. 1 is a cut-away view of a preferred embodiment of the foam-generating dispenser, 10, with a nozzle, 12, from which the foamed dishwashing composition is dispensed. The dishwashing composition enters the foam-generating dispenser via a dip tube, 14, and flows past a ball, 16, and into a cylinder, 18. A plug, 20, prevents the ball, 16, from escaping, and also supports a coil spring, 22, and a inner rod, 24. A liquid piston, 26, crates a suction which draws the dishwashing composition past the ball, 16 and the plug, 20, into a liquid chamber, 28, and thereby primes the foam-generating dispenser, 10. Meanwhile, an air chamber, 30, and an air piston, 31 are also primed, and when the activator, 32, is depressed, both the air from the air chamber, 30, and the dishwashing composition from the liquid chamber, 28, are turbulently forced into the mixing chamber, 34, and past a first mesh, 36 and a second mesh, 38, which are both kept in place by a mesh holder, 40. As the turbulent air/dishwashing composition mixture is forced past the first mesh, 36, a first, rough foam is generated, which becomes more fine and even after passing through the second mesh, 38. The first mesh and second mesh may have the same, or different pore sizes. Also, additional meshes may also be employed, as desired.

FIG. 1 also shows a base cap, 42, which secures the foaming dispenser to a container, 44, which holds the dishwashing composition.

Preferred foam-generating dispensers useful herein include: T8900, OpAd FO, 8203, and 7512 series foamers from Afa-Polytek, Helmond, The Netherlands; T1, F2, and WR-F3 series foamers from Airspray International, Inc., Alkmaar, The Netherlands or North Pompano Beach, Fla., U.S.A.; TS-800 and Mixor series foamers from Saint-Gobain Calmar, Inc., City of Industry, Calif., U.S.A.; pump foamers and squeeze foamers from Daiwa Can Company, Tokyo, Japan; TS1 and TS2 series foamers from Guala Dispensing USA, Inc., Hillsborough, N.J., U.S.A.; and YT-87L-FP, YT-87L-FX, and YT-97 series foamers from Yoshino Kogyosho Co., Ltd., Tokyo, Japan. Also see the foam-generating dispensers discussed in the Japanese-language publications Food & Package, (2001) vol. 42, no. 10, pp 609-13; Food & Package, (2001) vol. 42, no. 11, pp 676-79; and Food & Package, (2001) vol. 42, no. 12, pp 732-35. Variations and modifications of existing foam-generating dispensers may also be useful herein, especially if needed to optimize performance due to product rheology. Specifically, variations regarding the air piston:product piston volume ratio, mesh/net sizes, impinging angle, etc. are contemplated, as well as optimization of cylinder, rod, dip tube, nozzle, etc. sizes and dimensions.

The foam-generating dispenser useful herein generates a foam having a foam to weight ratio of greater than about 2 mL/g, more preferably from about 3 mL/g to about 10 mL/g, and even more preferably from about 4 mL/g to about 8 mL/g. Furthermore, the foam-generating dispenser useful herein generates at least about 2 mL foam, preferably from about 3 mL to about 10 mL, and more preferably from about 4 mL to about 8 mL, per mL of dishwashing composition. “Creamy” and “smooth” foams having fine bubbles dispersed relatively evenly throughout may be especially preferred for their aesthetic and/or performance characteristics. In certain cases, preferred foams are those which do not significantly degrade into liquid over a period of 3 minutes are especially preferred. Specifically, when the foam is dispensed onto a clean glass surface (e.g., a PYREX™ plate) and let sit for 3 minutes at 25° C., less than 1 mm of liquid should be apparent. Preferably, no liquid is visible at the edge of the foam after 3 minutes. However, in other cases, it has also been found that a certain amount of liquid (i.e., non-foam) is also preferable, as this liquid then permeates into the applicator (e.g., a sponge), and further extends the mileage of the high viscosity composition when it is used for, example, cleaning dishes.

Cleaning and/or Dishwashing Composition

The cleaning, and especially the dishwashing composition herein typically includes a surfactant system, a solvent, an enzyme, and one or more optional ingredients known in the art of cleaning and especially dishwashing, such as a dye, a perfume, a thickener, a pH controlling agent, a reducing or oxidizing bleach, an odor control agent, antioxidants and free radical inhibitors, and a mixture thereof.

The surfactant system herein typically includes an anionic surfactant, an amphoteric surfactant, a cationic surfactant, a nonionic surfactant, a zwitterionic surfactant, or a mixture thereof, preferably an alkyl sulfate, an alkoxy sulfate, an alkyl sulfonate, an alkoxy sulfonate, an alkyl aryl sulfonate, an amine oxide, a betaine or a derivative of aliphatic or heterocyclic secondary and ternary amine, a quaternary ammonium surfactant, an amine, a singly or multiply alkoxylated alcohol, an alkyl polyglycoside, a fatty acid amide surfactant, a C₈-C₂₀ ammonia amide, a monoethanolamide, a diethanolamide, an isopropanolamide, a polyhydroxy fatty acid amide and a mixture thereof. The surfactants useful herein may be further be branched and/or linear, substituted or unsubstituted, as desired. See also “Surface Active Agents and Detergents” (Vol. I and II by Schwartz, Perry and Berch).

The solvent useful herein is typically selected from the group consisting of water, alcohols, glycols, ether alcohols, and a mixture thereof, more preferably the group consisting of water, glycol, ethanol, glycol ethers, water, and a mixture thereof, even more preferably the group consisting of propylene carbonate, propylene glycol, tripropyleneglycol n-propyl ether, diethylene glycol n-butyl ether, water, and a mixture thereof. The solvent herein preferably has a solubility in water of at least about 12%, more preferably of at least about 50%, by weight of the solution.

Solvents which are capable of decreasing the product viscosity and/or imparting a shear-thinning or non-Newtonian rheology profile to the compositions are especially preferred herein, as they may synergistically interact with the foam-generating dispenser to provide improved aesthetics, easier formulation, higher foam generation, easier pumpability, etc. Such solvents include mono, di and poly hydroxy alcohols, ethers, and mixtures thereof. Alkyl carbonates such as propylene carbonate are also preferred.

The enzyme useful herein includes a cellulase, a hemicellulase, a peroxidase, a protease, a gluco-amylase, an amylase, a lipase, a cutinase, a pectinase, a xylanase, a reductase, an oxidase, a phenoloxidase, a lipoxygenase, a ligninase, a pullulanase, a tannase, a pentosanase, a malanase, a 13-glucanase, an arabinosidase and a mixture thereof. A preferred combination is a detergent composition having a cocktail of conventional applicable enzymes such as protease, amylase, lipase, cutinase and/or cellulase. An enzyme is typically present at from about 0.0001% to about 5% of active enzyme, by weight. Preferred proteolytic enzymes are selected from the group consisting of ALCALASE® (Novo Industri A/S), BPN', Protease A and Protease B (Genencor), and mixtures thereof. Protease B is more preferred. Preferred amylase enzymes include TERMAMYL®, DURAMYL® and the amylase enzymes described in WO 94/18314 A1 to Antrim, et al., published on Aug. 18, 1994 (assigned to Genencor International) and WO 94/02597 A1 to Svendsen and Bisg\dot{a}rd-Frantzen, published on Feb. 3, 1994 (assigned to Novo Nordisk A/S). Further non-limiting examples of preferred enzymes are disclosed in WO 99/63034 A1 to Vinson, et al., published on Dec. 9, 1999.

A microemulsion or a protomicroemulsion cleaning and especially dishwashing composition typically also contains a low water-soluble oil having a solubility in water of less than about 5,000 ppm, preferably from about 0 part per million (ppm) to about 1,500 ppm, by weight of the low water-soluble oil, and more preferably from about 1 part per trillion to about 100 ppm. Preferred low water-soluble oils useful herein include terpenes, isoparaffins, other oils having the above solubility, and a mixture thereof.

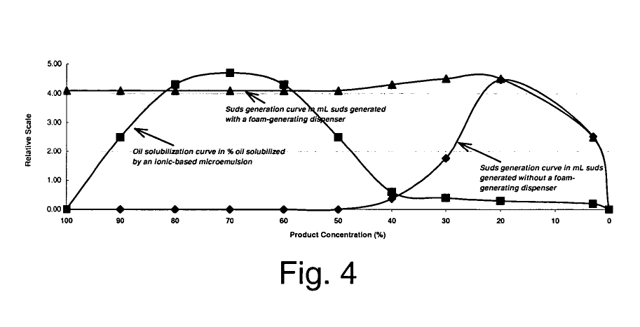

In the absence of a foam-generating dispenser, the cleaning and/or dishwashing composition here typically has an effective foaming dilution range of less than about 50%, preferably from about 0% to about 40%, and more preferably from about 0% to about 35% of the dilution range. However, in an embodiment of the invention herein, the dishwashing composition, when used with the foam-generating dispenser, has an effective foaming dilution range of at least about 50%, preferably from about 50% to about 100%, more preferably from about 75% to about 100%, and even more preferably from about 85% to about 100% of the dilution range. The effective foaming dilution range is calculated as follows: The suds generation curves of FIG. 4 are generated by testing various dilutions of a dishwashing composition via the suds cylinder test herein. Such a curve can be generated either with or without dispensing from a foam-generating dispenser into the cylinders. “Effective foam” is defined herein as foam which is at least half (50%) the maximum volume of foam generated for a given dishwashing composition according to the suds generation curve. Accordingly, in FIG. 4, for when the foam-generating dispenser is not employed, effective foam is formed from about 28% to about 2% product concentration, which translates into an effective foaming dilution range of 26% (i.e., 28%-2%). However, when the same cleaning and/or dishwashing composition is employed with (i.e., dispensed from) the foam-generating dispenser, it can be seen that effective foam is generated from the point of dispensing (100% product concentration) until a product concentration of about 3% is reached. This is because the cleaning and/or dishwashing kit generates foam at a substantially different dishwashing composition to water dilution than the dilution at which the maximum volume of foam is formed according to the suds cylinder test. Thus, the effective foaming dilution range when the dishwashing composition in FIG. 4 is dispensed from a foaming dispenser is 97% (i.e., 100%-3%).

The cleaning and/or dishwashing composition useful herein has an oil solubilization curve which is generated by the oil solubilization test defined herein. “Effective oil solubilization” is defined herein as oil solubilization which is at least 20% of the maximum amount of oil solubilized for a given dishwashing composition according to the oil solubilization curve which is plotted as a function of product concentration (i.e., dilution). Accordingly, in FIG. 4, the maximum amount of oil solubilized is about 4.7 at a 70% product concentration, and thus the effective oil solubilization is an amount of at least about 0.94. The effective oil solubilization occurs from dilution ranges of about 96% to about 42%, which translates into an effective oil solubilization dilution range of about 54%.

As it can be seen in FIG. 4, there is virtually no overlap between the suds generation curve without a foam-generating dispenser and the effective oil solubilization dilution range. Similarly, it can be seen that absent a foam-generating dispenser, there is no overlap between the effective foaming dilution range (28% to 2%) and the effective oil solubilization dilution range (from 42% to 96%). In contrast, when a foam-generating dispenser is employed, the effective foaming dilution range (from 3% to 100%) completely (100%) overlaps the entire effective oil solubilization dilution range (from 42% to 96%). In a preferred embodiment, the effective foaming dilution range overlaps the effective oil solubilization dilution range, preferably the effective foaming dilution range overlaps the effective oil solubilization dilution range by at least about 10%, more preferably by from about 25% to about 100%, and even more preferably from about 50% to about 100%, especially in the case of a microemulsion or a protomicroemulsion. Furthermore, it is highly preferred that the effective foaming dilution range overlaps the point in the oil solubilization curve where the oil solubilization is at a maximum. Thus, the present invention encourages a user to use the product at a concentration/product dilution which more effectively solubilizes oil, and thereby optimizes cleaning.

The present invention has recognized that such a dishwashing composition, and especially microemulsion and protomicroemulsion dishwashing compositions require the container and foam-generating dispenser herein to achieve consumer-acceptable foaming at a dilution where the oil solubilization curve is more effective, and preferably maximized. Accordingly, it is preferred that when the dishwashing composition is employed with the container and foam-generating dispenser, an effective foam is generated at a dilution factor significantly different from the suds generation curve when the container and foam-generating dispenser is not employed. Without intending to be limited by theory, it is believed that one skilled in the art would understand that such a graph is also generally applicable to a microemulsion and/or protomicroemulsion cleaning composition as described herein.

Hand dishwashing compositions, cleaning compositions, protomicroemulsion compositions and microemulsion compositions useful in the present invention are known in the art, as described in, for example, WO 96/01305 A1 to Farnworth and Martin, published on Jan. 18, 1996; U.S. Pat. No. 5,854,187 to Blum, et al., issued on Dec. 29, 1998; U.S. Pat. No. 6,147,047 to Robbins, et al., issued on Nov. 14, 2000; WO 99/58631 A1 to Robbins, et al., published on Nov. 18, 1999; U.S. Pat. No. 4,511,488 to Matta, issued on Apr. 16, 1985; U.S. Pat. No. 5,075,026 to Loth, et al., issued on Dec. 24, 1991; U.S. Pat. No. 5,076,954 to Loth, et al., issued on Dec. 31, 1991; U.S. Patent No. US05082584 to Loth, et al., issued on Jan. 21, 1992; U.S. Pat. No. 5,108,643 to Loth, et al., issued on Apr. 28, 1992; and co-pending U.S. Patent Application No. 60/451,064 (P&G Case # AA614FP), to Ford, et al., entitled “Protomicroemulsion, Cleaning Implement Containing Same, And Method Of Use Therefor”, filed on Feb. 28, 2003; co-pending U.S. Patent Application No. 60/472,941 (P&G Case # AA614P2), to Ford, et al., entitled “Protomicroemulsion, Cleaning Implement Containing Same, And Method Of Use Therefor”, filed on May 23, 2003; co-pending U.S. patent application Ser. No. 10/788,123 (P&G Case # AA614M), to Ford, et al., entitled “Protomicroemulsion, Cleaning Implement Containing Same, And Method Of Use Therefor”, filed on Feb. 26, 2004; and co-pending U.S. patent application Ser. No. 10/788,121 (P&G Case # AA633M), to Hutton and Foley, entitled “Protomicroemulsion, Cleaning Implement Containing Same, And Method Of Use Therefor”, filed on Feb. 26, 2004. (Serial numbers to be inserted when received.) The dishwashing compositions noted in the above references or variations of the above compositions, are especially preferred for use in combination with the container and foam-generating dispenser described herein.

The cleaning and/or dishwashing composition herein typically has a viscosity of less than about 10 Pa*s, preferably from about 0.01 Pa*s to about 10 Pa*s, more preferably from about 0.02 Pa*s to about 5 Pa*s, even more preferably from about 0.03 Pa*s to about 1 Pa*s, and even more preferably from about 0.05 Pa*s to about 0.4 Pa*s. When the cleaning and/or dishwashing composition is dispensed from the foam-generating dispenser, a foamed dishwashing composition is produced.

Shaped Applicator

It has further been discovered that a shaped applicator can surprisingly provide significantly improved results and ease of use as compared to a normal applicator. The shaped applicator is designed and sized to be easily held in the hand and is used to apply the foamed dishwashing composition to the surface to be cleaned, i.e., the dish. It has been found that if the foamed dishwashing composition is applied to a flat applicator, then the foamed cleaning and/or dishwashing composition is quickly wiped onto the first dish contacted, but that little foamed cleaning and/or dishwashing composition will remain on the flat applicator, for cleaning subsequent dishes. This makes the use of a foamed cleaning and/or dishwashing composition both expensive, as composition mileage is significantly decreased, and tiresome, as new foamed cleaning and/or dishwashing composition constantly needs to be applied to the flat applicator. In contrast, a shaped applicator which contains a receiving area, such as a protected indentation and/or a pocket, for the foamed cleaning and/or dishwashing composition will more effectively hold and mete out the foamed dishwashing composition over time.

As the shaped applicator will often be used for scrubbing, it is preferred that at least one surface thereof contain an abrasive surface. The shaped applicator is typically selected from a porous material such as a natural or artificial sponge, a brush, a metal scouring device, a woven material, a nonwoven material, an abrasive material, a plastic material, a cloth material, a microfiber cleaning material, a polymeric material, a resin material, a rubber material, or a mixture thereof, preferably a natural or artificial sponge, a brush, a metal scouring device, an abrasive material, a foam rubber material, a functional absorbent material (FAM), a polyurethane foam, and a mixture thereof, and more preferably a natural or artificial sponge, a brush, an abrasive material, a foam rubber material, and a mixture thereof, with all types of open-celled structures being highly preferred. Such shaped applicators are available from a variety of commercial sources, such as Minnesota Mining and Manufacturing Company (3M), St. Paul, Minn., U.S.A. If the shaped applicator is formed from a relatively delicate material, or a material which is easily torn, then it is preferable that this material be covered, partially or completely, with a water-permeable, more robust material, such as a nonwoven material. Also useful are surfaces formed from plastic or polymeric materials such as available from, for example, Minnesota Mining and Manufacturing Company (3M), St. Paul, Minn., U.S.A., and found on, for example, Scotch-Brite™ General Purpose Scrubbing Pads.

Preferably, the FAM useful herein has an absorbent ability of more than about 20 g H₂O/g, more preferably, 40 g H₂O/g by weight of FAM. Such a preferred FAM is described in U.S. Pat. No. 5,260,345 to DesMarais, et al., issued on Nov. 9, 1993 or U.S. Pat. No. 5,889,893 to Dyer, et al., issued on May 4, 1999. Examples of a preferred polyurethane is described in U.S. Pat. No. 5,089,534 to Thoen, et al., issued on Feb. 18, 1992; U.S. Pat. No. 4,789,690 to Milovanovic-Lerik, et al., issued on Dec. 6, 1988; Japanese Patent Publication No. 10-182780 to Kao Corporation, published on Jul. 7, 1998; Japanese Patent Publication No. 9-30215 to Yokohama Gum, published on Feb. 4, 1997; Japanese Patent Publication No. 5-70544 to The Dow Chemical Company, published on Mar. 23, 1993; and Japanese Patent Publication No. 10-176073 to The Bridgestone Company, published on Jun. 30, 1998.

Preferably, the shaped applicator is not hard, but instead has at least one resilient portion, preferably a resilient portion which is covered by an abrasive surface. Such an optional resilient portion allows the user to vary the amount of contact, pressure, etc., between the scrubbing surface and the dish. The foamed dishwashing composition is thus preferably applied into or onto the shaped applicator directly from the foam-generating dispenser.

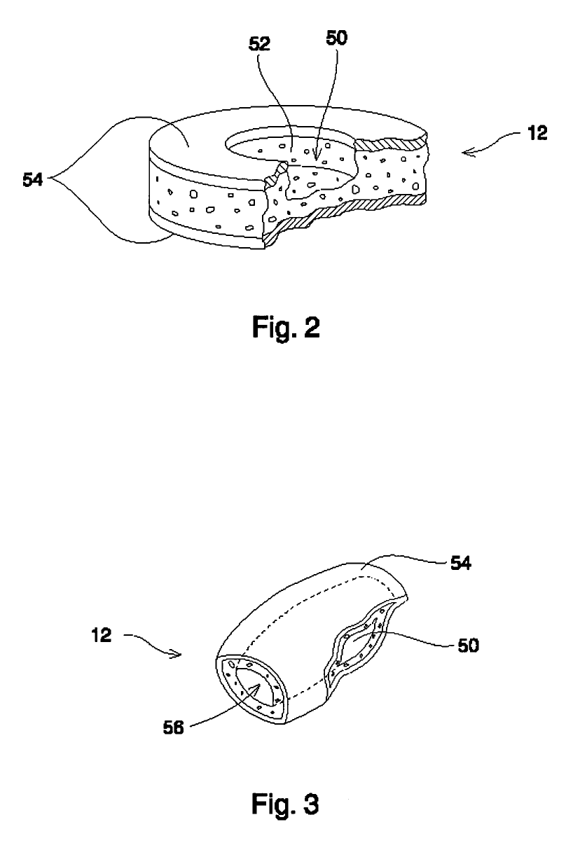

Turning to FIG. 2, which shows a top perspective, cut-away view of a preferred embodiment of the shaped applicator, 12, herein, a sponge-type shaped applicator, 12, contains a receiving area, 50, to which the foamed dishwashing composition is applied for use. The receiving area, 50, is therefore typically bounded by a wall, 52, which protects the foamed composition from being quickly rubbed off of the shaped applicator, 12. The receiving area is preferably a concave indentation in the shaped applicator which may be of any shape and design which keeps the foamed dishwashing composition in contact with the shaped applicator. In a preferred embodiment, the receiving area contains a relatively steep concave wall or other structure which effectively keeps the foamed detergent in the receiving area and dispenses it over time during typical use. Typically the receiving area holds from about 1 mL to about 200 mL, preferably from about 2 mL to about 150 mL, and more preferably from about 5 mL to about 100 mL of foamed dishwashing composition.

In FIG. 2, the shaped applicator, 12, further contains a plurality of abrasive surfaces, 54, for scrubbing a dish. It is highly preferred that at least one abrasive surface be provided on the shaped applicator.

FIG. 3 shows a perspective, cut-away view of a preferred embodiment of the shaped applicator, 12, which is formed as a sponge-type shaped applicator, 12, having a pocket-like receiving area, 50, whose internal dimensions are indicated by dashed lines. The foamed dishwashing composition is added to the receiving area, 50, via a mouth, 56, which may be permanently open, or may be closeable, as desired. An abrasive surface, 54, substantially covers the entire exterior of the shaped applicator, 12, to assist in removing stains from a dish.

Test Methods

The viscosity herein is measured on a Brookfield viscometer model # LVDVII+ at 20° C. The spindle used for these measurements is a S31 spindle with the appropriate speed to measure products of different viscosities; e.g., 12 rpm to measure products of viscosity greater than 1 Pa*s; 30 rpm to measure products with viscosities between 0.5 Pa*s-1 Pa*s; 60 rpm to measure products with viscosities less than 0.5 Pa*s.

To measure the solubilization capacity, 10.0 g of product (this amount includes water, if testing at a specific dilution) to be tested is placed in a 25 mL scintillation vial. To this, 0.1 g food grade canola oil dyed with 0.045% of Pylakrome RED—LX1903 (a mixture of SOLVENT RED 24 CAS# 85-83-6 and SOLVENT RED 26 CAS# 4477-79-6, available from Pylam Products, Tempe, Ariz., U.S.A.) dye is added, and the vial capped. The vial is shaken vigorously by hand for 5 seconds, and allowed to stand until it becomes clear via the ISO 7027 turbidity measuring procedure, or until 5 minutes has passed, whichever comes first. The ISO 7027 method measures turbidity at a wavelength of 880 nm with turbidity measuring equipment such as that available from Omega Engineering, Inc., Stamford, Conn., U.S.A. If the vial becomes clear, then more oil is added, in increments of 0.1 g, until the vial fails to become clear within the prescribed time. The % oil dissolution is recorded as the maximum amount of oil which was successfully solubilized (i.e., the vial is clear) by 10.0 g of product. Preferably, the dishwashing composition herein solubilizes at least about 1 g of dyed canola oil, more preferably at least about 3 g of dyed canola oil, and even more preferably at least about 4 g of dyed canola oil when tested at a 75% product concentration.

The sudsing profile can be measured by employing a suds cylinder tester (SCT), and using the data to plot a suds generation curve. The SCT has a set of 4 cylinders. Each cylinder is typically 30 cm long, and 10 cm in diameter. The cylinder walls are 0.5 cm thick, and the cylinder bottom is 1 cm thick. The SCT rotates a test solution in a closed cylinder, typically a plurality of clear plastic cylinders, at a rate of about 21 revolutions per minute, for 2 minutes, after which the suds height is measured. Soil may then be added to the test solution, agitated again, and the resulting suds height measured, again. Such a test may be used to simulate the initial sudsing profile of a composition, as well as its sudsing profile during use, as more soils are introduced from the surface being washed.

The sudsing profile test is as follows:

1. Prepare a set of clean, dry, calibrated cylinders, and water having a water hardness of 136.8 parts per million (2.1 grains per liter), and having a temperature of 25° C.

2. Add the appropriate amount of test composition to each cylinder and add water to make a total 500 mL of composition+water in each cylinder.

3. Seal the cylinders and place them in the SCT.

4. Turn on the SCT and rotate the cylinders for 2 minutes.

5. Within 1 minute, measure the height of the suds in centimeters.

6. The sudsing profile is the average level of suds, in cm, generated by the composition.

The compositions according to the invention preferably have a sudsing profile maxima of at least about 2 cm, more preferably at least about 3 cm, and even more preferably about 4 cm.

The foam to weight ratio is a measurement of the mL of foam generated per gram of product. Foam to weight ratio is measured as follows: a volumetric measuring device, such as a graduated cylinder is weighed to get a tare weight. Then, the product is dispensed, using the foam-generating dispenser, if appropriate, into a graduated cylinder a set number of strokes for non-continuous dispensing devices or for a set time period for continuous dispensing devices. 10 strokes for non-continuous devices (pumps, sprayers) or 10 seconds for continuous devices is the suggested duration. The dispensing rate in the test should be consistent with the dispensing rate during normal usage scenarios. For example, 120 strokes per minute for trigger sprayers, or 45 strokes per minute for palm pumps.

The volume of foam generated is measured in mL using the volumetric measuring device. The volumetric measuring device containing the dispensed product is weighed in grams. The tare weight of the volumetric measuring device is subtracted from this weight. The result is the grams of the product dispensed. Finally, the foam to weight ratio in mL/g is calculated by dividing the volume of foam generated (in mL) by the weight product dispensed (in g).

The foam to weight ratio of mL/g is easily converted to mL foam per mL of product by multiplying by the density of the dishwashing composition.

Examples of the invention are set forth hereinafter by way of illustration and are not intended to be in any way limiting of the invention. The examples are not to be construed as limitations of the present invention since many variations thereof are possible without departing from its spirit and scope.

### EXAMPLE 1

A dishwashing kit contains a 300 mL hollow plastic container filled with a microemulsion dishwashing composition, and an attached T1 series foamer from Airspray, similar to that shown in FIG. 1. A shaped applicator according to FIG. 3 is also included. When dispensed, the foamed dishwashing composition has a foam to weight ratio of greater than 2 mL/g, and the foam has a creamy, even look and feel. The foamed dishwashing composition is dispensed from the foaming dispenser into a pocket-type shaped applicator by sticking the nozzle of the foam-generating dispenser into the mouth of the shaped applicator, and pressing down on the activator. When used as described above, the dishwashing kit provides good mileage, and a foam which lasts throughout the normal use to clean dishes. However, if the foam-generating dispenser is not used (i.e., the dishwashing composition is merely poured out of the container), the effective foaming dilution range does not significantly overlap the effective oil solubilization dilution range.

### EXAMPLE 2

An ionic-based microemulsion is provided, packaged with the foam-generating dispenser of Example 1. The suds generation curves with and without employing the foam-generating dispenser, and the oil solubilization curve are plotted, resulting in FIG. 4.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A dishwashing kit comprising:
A. a container comprising a foam-generating dispenser for generating a foam; and
B. a dishwashing composition contained within the container, the dishwashing composition comprising:
i. a surfactant system; and
ii. a solvent,
wherein when employed with the dishwashing composition, the foam-generating dispenser generates a foam having a foam to weight ratio of greater than about 2 mL/g.

2. The dishwashing kit according to claim 1, wherein the dishwashing composition further comprises an enzyme.

3. The dishwashing kit according to claim 1, further comprising a shaped applicator.

4. The dishwashing kit according to claim 1, wherein the foam-generating dispenser comprises a gas imparting mechanism.

5. The dishwashing kit according to claim 1, wherein the dishwashing composition is selected from the group consisting of a microemulsion and a protomicroemulsion.

6. A dishwashing kit comprising:
A. a container comprising a foam-generating dispenser for generating a foam; and
B. a dishwashing composition contained within the container, the dishwashing composition comprising:
i. a surfactant system; and
ii. a solvent,
wherein when dispensed from the foam-generating dispenser, the dishwashing composition has an effective foaming dilution range of at least about 50% of the dilution range.

7. A dishwashing kit comprising:
A. a container comprising a foam-generating dispenser for generating a foam; and
B. a dishwashing composition contained within the container, the dishwashing composition comprising:
i. a surfactant system; and
ii. a solvent,
wherein when dispensed from the foam-generating dispenser, the dishwashing composition has an effective foaming dilution range and an effective oil solubilization dilution range, and wherein the effective foaming dilution range overlaps the effective oil solubilization dilution range.

8. A dishwashing kit comprising:
A. a container comprising a foam-generating dispenser for generating a foam; and
B. a dishwashing composition contained within the container, the dishwashing composition comprising:
i. a surfactant system; and
ii. a solvent,
wherein when dispensed from the foam-generating dispenser, the dishwashing kit generates foam at a substantially different dishwashing composition to water dilution than the dilution at which the maximum volume of foam is formed according to a suds cylinder test.

9. A shaped applicator for use with a dishwashing kit according to any one of claims 1, 6, 7 or 8.

10. A dishwashing composition comprising:
A. a surfactant system;
B. a solvent; and
C. an instruction set comprising a recommendation to employ the dishwashing composition in combination with a foam-generating dispenser,
wherein when employed with the dishwashing composition, the foam-generating dispenser generates at least about 2 mL foam per mL of the dishwashing composition and wherein the foam has a foam to weight ratio of greater than about 2 mL/g.

11. A cleaning kit comprising:
A. a container comprising a foam-generating dispenser for generating a foam; and
B. a composition contained within the container, the composition being selected from the group consisting of a microemulsion and a protomicroemulsion, and the composition comprising:
i. a surfactant system; and
ii. a solvent,
wherein when employed with the composition, the foam-generating dispenser generates a foam having a foam to weight ratio of greater than about 2 mL/g.

12. The cleaning kit of claim 11, wherein composition has an effective foaming dilution range and an effective oil solubilization dilution range, and wherein the effective foaming dilution range overlaps the effective oil solubilization dilution range.
